(19) United States
(12) Patent Application Publication
(10) Pub. No.: US 2003/0181836 A1
(43) Pub. Date: Sep. 25, 2003

(54) Device for relieving heel pain

(76) Inventor: Carl Alfred Cameron, Silver Spring, MD (US)

Correspondence Address: Carl A. Cameron, 917 Hyde Road, Silver Spring, MD, 20902, US

(21) Appl. No.: 10/104,958

(22) Filed: Mar. 25, 2002

(51) Int. Cl. A61H 15/00

(52) U.S. Cl. 601/115; 601/118

(57) ABSTRACT

A unique biomechanical exercise and conditioning device for rehabilitating the ligaments, tendons, and muscles in the foot and lower leg with the purpose of alleviating heel and foot pain, which can lead to heel spurs. The exercise and conditioning device comprises a single, spherical surface that spins about a rod that has been set into a box. Approximately, one-third of the upper portion of the sphere is positioned above the top of the box. The user will place one foot on the sphere, press down upon it, and roll the affected foot across the sphere repeatedly. This motion will massage and stretch the foot. This action will help to loosen tight membranes and muscle fibers in the foot that cause pain when a person stands on the affected body part.

### BACKGROUND OF THE INVENTION

The plantar fascia is a flat tissue that runs between the heel and the ball of the foot. It supports the arch of the foot. When the plantar fascia becomes stressed the tissue tightens, becomes inflamed, or tears. This causes sharp pains in the heel or arch of the foot. The condition can be improved by strengthening, stretching and massaging the foot; using orthotics; or using anti-inflammatory medications. In some cases, symptoms may not fade for a year.

The foot can be strengthened by performing several sets of calf raises on a calf machine or by standing with the balls of your feet on the edge of a step and flexing and extending the foot throughout its range of motion. Another strengthening exercise involves laying a towel on the floor and pulling it towards you by grabbing it with your toes. Or, pick up a golf ball with your toes, hold it for 30 seconds, and repeat several times.

To stretch the plantar fascia, place a golf ball behind your big toe and roll it down the foot to your heel, then roll the ball back to the second toe, and back to the heel (The present invention is intended to be similar to this stretching action). Cover the entire foot repeatedly. Next, place the balls of your feet on the edge of a step and slowly lower the heels. This stretches the Achilles' tendon and plantar fascia. Hold for 30 seconds and repeat hourly.

Orthotics will position the foot correctly. They range in price from ten to several hundred dollars. A study done by the American Orthopedic Foot and Ankle Society, found that three shoe inserts that cost between $10.00 and $40.00 performed better than custom made inserts that cost between $180.00 and $500.00.

Anti-inflammatory medicines such as aspirin may help to reduce swelling and pain. If that does not work, your doctor may suggest cortisone injections or surgery.

If heel pain is not corrected, the tissues in the foot may tear. These tears cause microscopic bleeding which calcifies. Heel spurs are a build-up of this calcified material on the bottom of the foot. Pain and stiffness are most intense upon rising or at the start of an exercise session. The condition can be helped with orthotics, taping, icing, massage, stretching, ultrasound, anti-inflammatory medication, and as a last resort, surgery.

1. Field of the Invention

The present invention generally relates to the field of exercise devices. More particularly, the invention relates to stretching and conditioning devices that will help persons avoid or recover from maladies of the foot, such as plantar fasciitis, that are caused by the tightening and inflammation of the membrane on the sole of the foot, known as the plantar fascia.

2. Description of the Prior Art

Traditionally, conditions similar to plantar fasciitis are treated through a physician's prescription for custom made orthotics, the use of off-the-shelf orthotics, ultrasound therapy, manually massaging the foot, or stretching the sole of the foot by rolling a golf or tennis ball along the bottom of the foot.

The following three (3) foot massaging devices represent prior art patents that are pertinent to the field of heel pain therapy:

1. U.S. Pat. No. 6,234,987 issued to Chen on May 22, 2001 for “Foot Heel Massaging Device” (hereafter the “Chen Patent”).

The Chen Patent discloses a foot heel massaging device that is located in the heel of a shoe to massage the foot heel of a person wearing the shoe. The device consists essentially of a fixed member located fixedly in the shoe heel, a movable member located movably on the fixed member and provided with a plurality of massaging knobs, a confining member for confining the fixed member and the movable member, and two magnets located respectively in the fixed member and the movable member such that the like magnetic poles of the two magnets are opposite to each other to bring about a repulsion force to cause the movable member to move away from the fixed member at the time when the movable member is relieved of an external force exerting thereon.

2. U.S. Pat. No. 5,830,161 issued to Cosmano on Nov. 3, 1998 for “Alternating Ribbed Foot Massager” (hereafter the “Cosmano Patent”).

The Cosmano Patent discloses a foot massager that is built around a cylinder that preferably mounts two axially spaced longitudinally ribbed, bulging sleeves separated by a radially extended central partition disk and captured at their outer ends by roller disks, each having end stops to prevent the massager from rolling too far. The sleeve has alternating short and substantially compressible tall ribs to clutch the skin of a user's foot and thereby enhance the soothing effect. The cylinder mounts a vibrator internally. The user places his feet respectively on the two bulged sleeves, turns on the vibrator, and rolls his feet forward and backward in a reciprocating motion that rolls the vibrator on the floor beneath his feet. The configuration of the ribbed sleeves is such that the user can roll his feet against curved end ramps defined on both the inside (the side closer to the other foot) and outside of each foot for a complete massage of all foot surfaces.

3. U.S. Pat. No. 5,827,205 issued to Iwamoto on Oct. 27, 1998 for “Foot vibrator massager having a pair of solenoids” (hereafter the “Iwamoto Patent”).

The Iwamoto Patent discloses a foot massager having massaging applicators and capable of holding the feet of a user stably thereon to avoid an accidental actuation of a control section by the feet. A massager housing has an inclined top wall. The applicators are supported to the inclined top wall and are movable in a massage direction perpendicular to a general outer surface of the inclined top wall. Mounted within the housing are a pair of solenoids each having a plunger of which longitudinal axis is aligned with the massage direction. The plunger is connected at its upper end with the applicator and is attracted by repetitive energization of the solenoid to periodically move the applicator upward along the massage direction from a depressed position where the applicator is depressed by the foot of the user, thereby giving a tapping massage action to the foot. The control section is provided on a lower portion of the top wall adjacent to a front lower end of the housing and includes a switch for actuating the solenoid. The applicators are disposed in an upper portion of the inclined top wall adjacent to a rear upper end of the housing. Projected between the applicators and the control section is a heel stopper that bears the heels of the foot placed on the applicator. Thus, the heel stopper prevents the user's feet from slipping towards the control section and therefore protects the control section from being actuated by the user's heel during the massage.

The following three (3) ultrasound and thermal devices represent prior art patents that are pertinent to the field of heel pain therapy:

4. U.S. Pat. No. 6,251,088 issued to Kaufman, et al. on Jun. 26, 2001 for “Ultrasonic plantar fasciitis therapy: apparatus and method” (hereafter the “Kaufman Patent”).

The Kaufman Patent discloses a non-invasive therapeutic treatment of plantar fasciitis in vivo using ultrasound that is performed by subjecting a foot locale to an ultrasound signal supplied to an ultrasound transducer placed on the skin, and involving a repetitive finite duration signal consisting of plural frequencies that are in the ultrasonic range to ten MHz. The ultrasound transducer is reproducibly positioned using an ultrasound fixture. The ultrasound signal is applied daily at least twice per day for 40 minutes per treatment, and has a power intensity (SATA) of 18 mW/cm.sup.2. In an alternative embodiment, an orthotic device holds the foot in dorsiflexion concomitant with ultrasound treatment.

5. U.S. Pat. No. 5,954,675 issued to Dellagatta on Sep. 21, 1999 for “Method Of Ultrasonic Therapy” (hereafter the “Dellagatta Patent”).

The Dellagatta Patent discloses that methyl nicotinate, when swabbed onto the skin prior to the application of therapeutic ultrasound, produces a surprising enhancement of the effect of the ultrasound treatment, making it possible to use less power and to apply the ultrasound over a shorter interval, and requiring no significant waiting time for the nicotinic acid ester to take effect.

6. U.S. Pat. No. 6,074,414 issued to Haas, et al. on Jun. 13, 2000 for “System for providing thermal application to external body areas of a patient” (hereafter the “Haas Patent”).

A thermal applicator for medical use that is worn upon the body of a patient to modify its temperature for therapeutic treatment. The preferred embodiment of the present invention contemplates the utilization of a heat pipe having first and second ends and a length, the first and second ends communicating with first and second thermally conductive plates, respectively, the first thermally conductive plate configured to communicate with an exterior portion of the body of the patient and to provide localized thermal treatment, the second thermally conductive plate placed at an area removed from the area to be treated, and configured to accept, for example, an ice pack (or other thermal material or apparatus) to affect a change in the temperature of the second thermally conductive plate, cooling the second end of the heat pipe and allowing the heat pipe to cool the first thermally conductive plate, thereby providing localized cooling of the area to which it is applied. An alternative embodiment of the invention contemplates a heat source in lieu of the ice pack, wherein the second thermally conductive plate would function as an evaporator, thereby providing a reverse cycle in the heat pipe, for heating the area to be treated via the first thermally conductive plate. The present invention may be utilized for localized thermal application on various parts of the body, and several examples are illustrated, including an exemplary system to treat plantar fasciitis.

The following three (3) orthotic devices represent prior art patents that are pertinent to the field of heel pain therapy:

7. U.S. Pat. No. 6,315,786 issued to Smuckler on Nov. 13, 2001 for “Device For Treating Heal Pain” (hereafter the “Smuckler Patent”).

An orthotic device for treating heel pain associated with Plantar Fasciitis is disclosed, comprised of a flexible heel cup shoe insert with a bar-shaped member extending laterally across the bottom sole portion of the device and located under the heel-arch connection of a person's foot when worn by the person in order to apply continuous acupressure to the calcaneus-midtarsal connection area and thus alleviate pain.

8. U.S. Pat. No. 6,131,311 issued to Brown, et al. on Oct. 17, 2000 for “Insole Insert For Footwear” (hereafter the “Brown Patent”).

An insole insert comprises a body having a bottom portion, a heel edge, a lateral side edge, a medial side edge, a depression portion spaced generally centrally beneath the user's first metatarsal phalangeal joint, a heel portion formed along the heel lateral side edges and extending forwardly to just rearwardly of the user's fifth metatarsal phalangeal joint, and an arch portion formed along the medial side edge and extending forwardly to just rearwardly of the depression portion. The heel portion and the arch portion, which form a channel that is laterally angularly offset relative to the insole insert, are configured to cooperatively redistribute the normally greater weight-generated forces applied to the inner and more bony regions of the user's heel outwardly toward the outer and more fleshy regions of the user's heel. The bottom portion, the depression portion, the heel portion, and the arch portion are configured to cooperatively redistribute weight-generated forces operatively bearing against the sole of the user's foot such that greater weight-generated forces normally bearing against certain regions of the arch and forefoot of the user's foot are substantially reduced and redistributed toward other regions whereat smaller weight-bearing forces normally bear against the sole of the user's foot.

9. U.S. Pat. No. 5,865,779 issued to Gleason on Feb. 2, 1999 for “Orthotic Device For Treatment Of Plantar Fasciitis” (hereafter the “Gleason Patent”).

An elastic sock for treating Plantar Fasciitis, wherein the sock has a heel opening and exerts compressive forces along the longitudinal and transverse axes of a patient's foot.

It is desirable to have a device that efficiently applies pressure to the affected area of the foot in order to achieve a loosening and relaxation of inflamed tissues that have seized up because of the lack of flexibility or injury to them. The present invention will allow the individual user to determine the amount of pressure to apply to their body at the focal point of discomfort.

### BRIEF SUMMARY OF THE INVENTION

This device is intended to relieve heel and foot pain caused by weakness, a lack of flexibility, and injuries to the feet. There are numerous conditions that may cause such pain. One of the most common is plantar fasciitis.

The device alleviates heel and foot pain, which can lead to heel spurs, by providing a single, spherical surface that spins about a rod that has been set into a box. Approximately, one-third of the upper portion of the sphere is positioned above the top of the box. The user will place one foot on the sphere, press down upon it, and roll the affected foot across the sphere repeatedly. Start at the largest toe, roll down to the heel, roll up the foot to the second toe, and back to the heel again. Move back and forth in such a manner until the foot has been repeatedly covered. This motion will massage and stretch the foot. This action will help to loosen tight membranes and muscle fibers in the foot that cause pain when a person stands on the affected body part.

The device will have a layer of material on its underside to prevent it from moving across the floor while in use. This bottom material may extend across the entire underside of the device or it may only be affixed along the edges.

### BRIEF DESCRIPTION OF THE SEVERAL VIEWS OF THE DRAWING

FIG. 1 is a perspective view of the present invention, stretching device;

FIG. 2 is a plan view of the side of the present invention, stretching device;

FIG. 3 is a plan view of the top of the present invention, stretching device;

FIG. 4 is a sectional view taken along the line 7-7 of FIG. 1; and

FIG. 5 is a sectional view from the top of the present invention, 0.50 inches below the highest point of top surface 3 of FIG. 1.

### DESCRIPTION OF THE PREFERRED EMBODIMENT

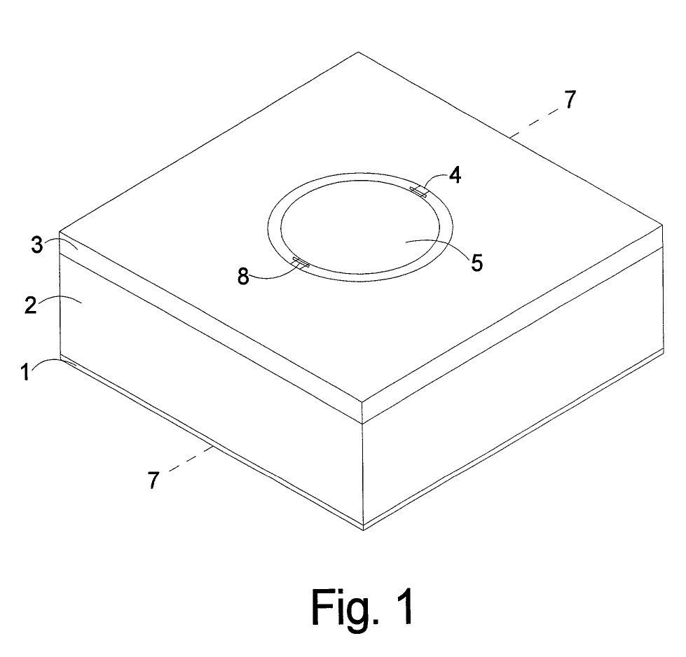

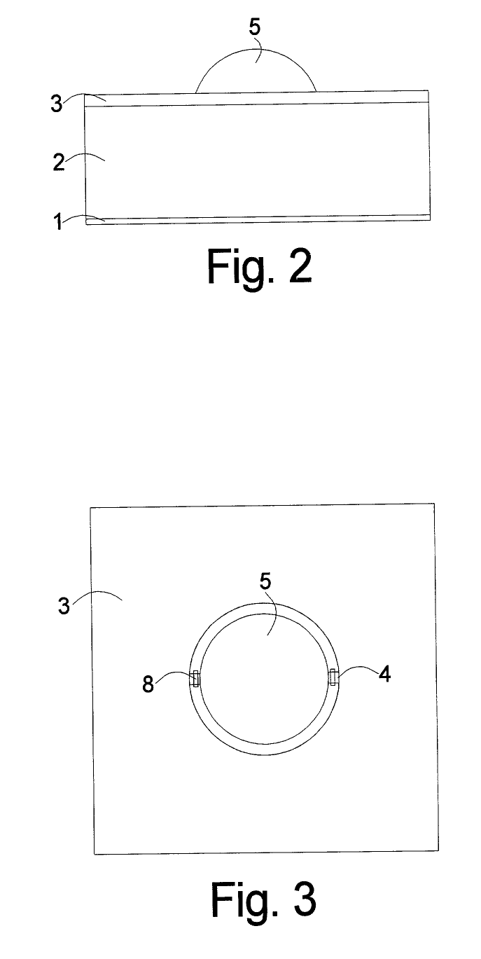

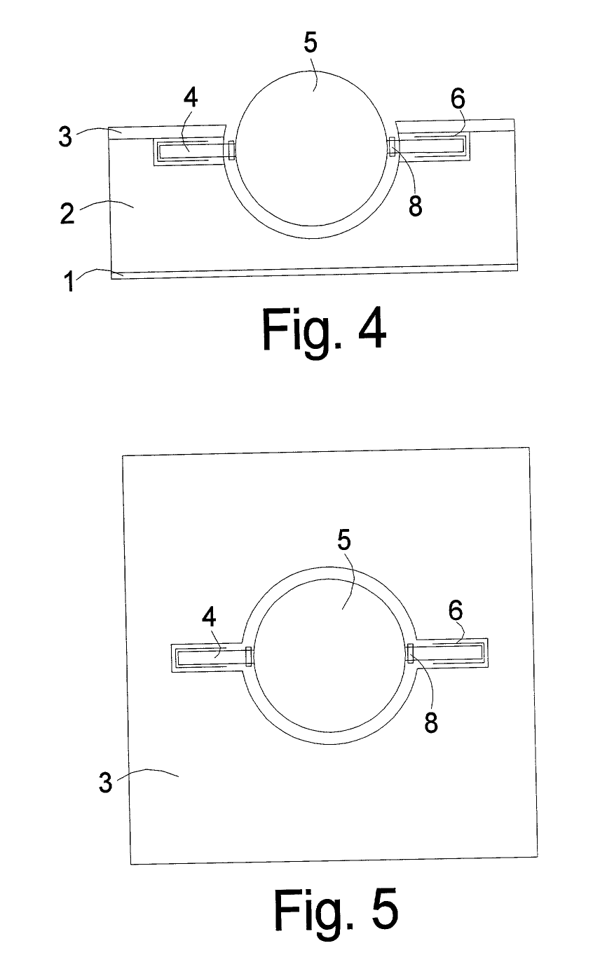

Referring to the entirety of FIG. 1, there is shown a perspective view of the present invention, a stretching and conditioning device. Sides of the device not revealed in FIG. 1 have the same structure as those sides that are depicted.

The present device has a base 1 designed to prevent slippage. It may cover the entire bottom of the present device or merely extend around the edges of the present device.

A side 2 connects to base 1 and serves to support metallic sleeves 6 which encircles metallic shaft 4. A ball is centered about metallic shaft 4. This ball is used to apply pressure upon the foot of the user of the present device. Metallic shaft 4 and metallic sleeve 6 are kept in place by top 3, which is affixed to side 2. The ball is kept in place by metallic stops 8, which are affixed one-eighth inch (⅛″) to either side of the ball when it is centered in the exercise device. metallic sleeve 6 are kept in place by top 3, which is affixed to side 2 The ball is kept in place by metallic stops 8, which are affixed one-eighth inch (⅛″) to either side of the ball when it is centered in the exercise device.

Although specific embodiments of the present invention will be described below, it should be understood that such embodiments are given merely to be illustrative of a few specific embodiments out of many that might be used to create such a device. One skilled in the art of manufacturing could make such a device with various materials, such as wood, metal, or plastic Also, one skilled in the art of manufacturing could make such a device with the box portion comprising various shapes, such as rectangular or circular from the top view. A variety of methods could be used to construct the present invention, depending upon which material was chosen. Various changes and modifications obvious to one skilled in the art to which the present invention pertains are deemed to be within the spirit, scope, and contemplation of the present invention that is further defined in the following claims.

What is claimed is:

1. A device for relieving heel pain for an individual, comprising:
a. a rigid ball with a metallic rod passing through its center that can spin freely about the rod,
b. a thin metallic sleeve that covers each end of the said metallic rod, the purpose of which is to decrease the friction of the ball and rod when the exercise and conditioning device is in use,
c. metallic stops affixed to the metallic rod that are set one-eighth inch (⅛″) to either side of the ball when it is centered in the exercise device, which are intended to keep the ball from rubbing against the sides of the box;
d. a box-like platform capable of supporting the rod and the weight of a large adult human who will place the weight of his/her body upon the ball spoken of in “claim 1 a.” above;
e. a top that will be affixed above the box-like platform that will hold the metallic rod in its position,
f. a layer of material affixed to the underside of the box-like platform designed to prevent the exercise device from moving about while it is being used of a variety of surfaces,
g whereby when the individual stands on said exercise device, the individual has the ability to stretch and condition the muscles, tendons, and joints of the foot
